(19) United States
(12) Patent Application Publication
(10) Pub. No.: US 2019/0226413 A1
(43) Pub. Date: Jul. 25, 2019

(54) ADJUSTMENT OF AN INTERNAL COMBUSTION ENGINE

(71) Applicant: FEV Europe GmbH, Aachen (DE)

(72) Inventor: Marcel Romijn, Tricht (NL)

(21) Appl. No.: 16/253,777

(22) Filed: Jan. 22, 2019

(30) Foreign Application Priority Data
Jan. 24, 2018 (DE) 102018101562.3

(51) Int. Cl. F02D 41/00

(52) U.S. Cl. CPC F02D 41/0077

(57) ABSTRACT

Method for adjusting an adjustment value of an internal combustion engine such as, in particular, the inert gas value in the combustion chamber of the internal combustion engine, wherein in a first operating state of the adjustment manipulated variables which influence the adjustment value are adjusted independently of one another in order to optimize the adjustment value, and when a fault or an optimization requirement is detected the controller selects one or more manipulated variables in a second operating state, in order thereby to bring about optimization of the adjustment value by means of enhanced use of this manipulated variable/these manipulated variables.

### CROSS-REFERENCE TO RELATED APPLICATIONS

This Application claims priority from Application 102018101562.3 filed on Jan. 24, 2018 in Germany.

### FIELD OF THE INVENTION

The present invention relates to a method for adjusting an internal combustion engine, to an engine controller and to an engine.

### BACKGROUND OF THE INVENTION

The adjustment of the combustion parameters of an internal combustion engine is a problem which has been known for a long time. In this context, the requirement to optimize the emission of pollutants (e.g. NOx), to reduce the fuel consumption or the emission of particles, can arise as a function of the required boundary conditions. The inert gas value in the combustion chamber is a variable which is highly important for the combustion and which is therefore preferably suitable as an adjustment variable. In addition, it is known that open-loop and/or closed-loop control of the portion of the inert gas in the combustion chamber can be performed in many ways. These include inter alia a low-pressure EGR (low-pressure exhaust gas recirculation rate). This is also possible by means of a high-pressure EGR (high-pressure exhaust gas recirculation rate). In addition, the inert gas in the combustion chamber can be open-loop or closed-loop controlled by means of a VVT/VVL (variable valve timing/valve lift) system. Corresponding influences are brought about by the fresh air supply (pressure and/or mass flow rate) or the fuel supply. In many cases, in internal combustion engines which are known at present a plurality of control loops are used in parallel and are set automatically so as to produce the best possible combustion result.

Given the current legislation it is necessary, for example for the Euro7 Standard, to monitor the EGR systems and the VVT/VVL systems in the form of an ODB (on-board diagnosis), that is to say in real time. Different standards such as, for example, for the emission cycle (FTP75 in the USA, WLTC in China and EU), prescribe limiting values for fault detection. In this context, the emission value is obtained as a combination of the different influencing factors which are explained below in detail. In the case of VVT/VVL systems, it necessary monitor on a standard basis whether the controllers are capable of bringing about the setpoint state. In the case of conventional exhaust gas recirculation, it is therefore possible to achieve NOx reduction, and the EGR is monitored by measuring the fresh air stream in relation the fluid stream, which flows through the engine and is diverted as an exhaust gas.

In addition, there are modern and relatively complex systems in which a combination of a plurality of exhaust gas recirculation systems (low-pressure EGR and high-pressure EGR) and VVT/VVL is used in order thereby to optimize the combustion conditions. As a result, it is possible to bring about a specific inert gas value in the combustion chamber by means of a selection and/or a combination of those influencing factors which differ from one another here.

### SUMMARY OF THE INVENTION

The object of the present invention is to improve the combustion result according to predefined requirements. The requirements can comprise, for example, reducing the emission of pollutants or improving the combustion efficiency. In addition, the object consists in developing an on-board diagnosis system order to detect faults which influence the combustion conditions and at the same time bring about an indication of the part of the system in which the fault has occurred, and in addition and also to propose an adjustment structure in order to achieve the best possible combustion result despite a disruption or a fault. This object is achieved with the features of Claim 1. Preferred developments are the subject matter of the dependent claims.

In a method for adjusting an adjustment value of an internal combustion engine such as, in particular, the inert gas value in the combustion chamber of the internal combustion engine, in a first operating state manipulated variables which influence the adjustment value are adjusted independently of one another in order to optimize the adjustment value. And when a fault or an optimization requirement detected, in a second operating state the controller selects one or more manipulated variables in order thereby to bring about the optimization of the adjustment value by means of enhanced use of this manipulated variable/these manipulated variables. The fault or the optimization requirement can be detected by virtue of the fact that the adjustment value which is to be optimized does not lie in its setpoint range and/or are detected by virtue of the fact that one or more sensors which detect the state of one or more manipulated variables arrive at the result that one or more manipulated variables are not operating in their setpoint range. In the control loops according to the prior art, value was not placed upon which parameters were changed and how they were they changed in order to obtain the target range of the adjustment value. In contrast, according to the invention it has been recognized that it is not insignificant which portion of which manipulated variables is used to obtain the adjustment value (in so far as it is possible in terms of adjustment technology), since, in contrast, in some cases it may be advantageous to use a manipulated variable to an enhanced degree, and in other cases perhaps to use another manipulated variable.

In a method for adjusting an adjustment value of an internal combustion engine, a plurality of manipulated variables are set to predefined values in order to obtain the desired adjustment value, and when the adjustment value differs from a setpoint value a controller decides which manipulated variable is changed, either alone or in combination with other manipulated variables, in order to compensate for the deviation. In this decision step, at least two options are available for selection, and the intended decision can be made by the controller as a function of advantages which do not relate directly to the adjustment value, specifically, in particular, as a function of other optimization advantages, by means of an adaptation of which manipulated variables are intended to bring about the adjustment result. This approach is based largely on the same inventive concept as the abovementioned approach, with the particular feature that it is not absolutely necessary to carry out a step without an optimization process which is weighted in such a way.

Sensors are advantageously provided for at least some of the manipulated variables in order to check individually for an assigned manipulated variable whether it is set to the predefined value. The sensors are advantageous for detecting which manipulated variable is specifically disrupted in the case of fault of the entire system. In particular, at least two of the following manipulated variables can be used:—a low-pressure EGR rate,—a high-pressure EGR rate,—a VVT and/or VVL value,—a fresh gas supply,—a quantity of the fuel supply. A preferred method uses the first-mentioned three manipulated variables.

In addition, in particular, in order to determine the adjustment value the controller can adjust at least three manipulated variables and preferably adjust precisely three manipulated variables. The advantage of the present invention occurs particularly starting from the number of three manipulated variables since in the event of a failure/fault of one of the manipulated variables there are still at least two remaining manipulated variables from which a selection can be made and between which weighting can be carried out.

The controller determines the inert gas value in the combustion chamber preferably on the basis of predefined and/or measured engine conditions and uses said value as an adjustment value. The inert gas value is a very important value, since the quality of the exhaust gas is strongly influenced thereby. It is therefore particularly suitable as a value which is to be optimized.

In addition, in order to detect faults, deviations of the adjustment value from the setpoint value can be summed over a defined time period, and when the summed deviations are exceeded or undershot in comparison with a limiting value a fault or an optimization requirement can be detected. In particular or alternatively, the method is configured to detect one-off deviations of the adjustment value from a limiting value.

In particular, when a fault or an optimization requirement is detected, the value of the manipulated variables which are provided with an individually assigned sensor are interrogated, in order thereby to detect a manipulated variable which operates in a non-optimum fashion, and subsequently at least one other manipulated variable is selected in order to use said manipulated variable to compensate the manipulated variable which operates in a non-optimum fashion. Therefore, the controller receives the necessary data in order to perform corresponding optimization in a targeted fashion.

### DESCRIPTION OF THE DRAWINGS

The invention will be explained by way of example below on the basis of figures a referred embodiment, in which figures:

FIG. 1 shows a schematic view of an internal combustion engine;

FIG. 2 shows a schematic view of a fault free operating state;

FIG. 3 shows a schematic of an adjustment state where VVT/VVL valve has dropped significantly; and

FIG. 4 shows a schematic view of an adjustment state where VVT/VVL has dropped extremely low.

### DETAILED DESCRIPTION

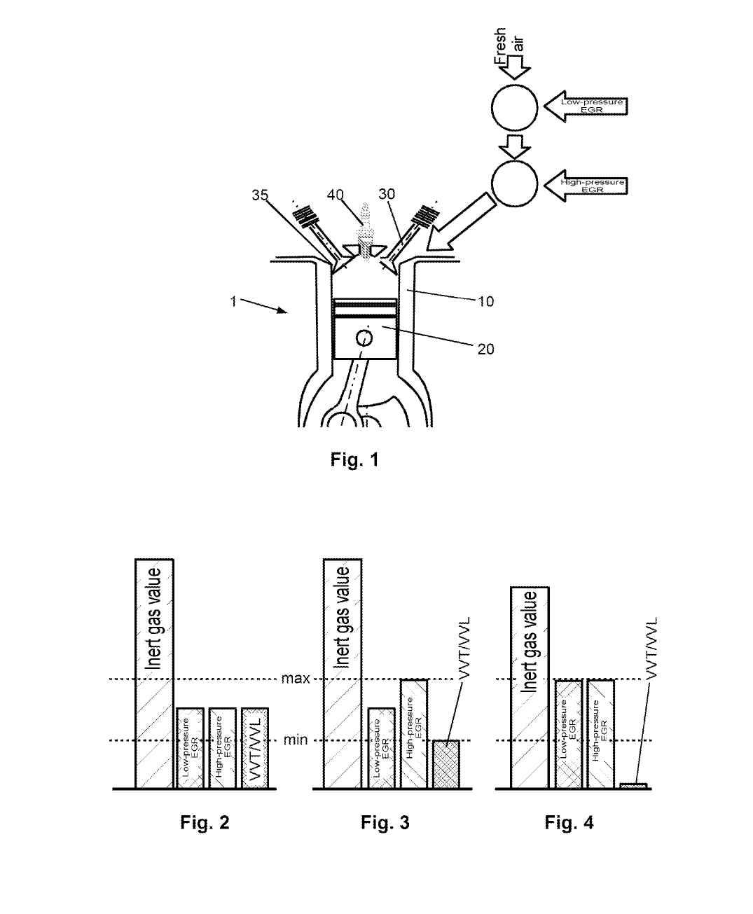

FIG. 1 shows a section through an internal combustion engine 1, with a piston 20 which is guided in a cylinder 10, a spark plug 40, an inlet valve 30 and an outlet valve 35. In addition, the fluid stream which is fed into he internal combustion engine 1 through the inlet valve 30 is indicated schematically. This fluid stream comprises fresh air which is sucked in from the outside. This fresh air stream can be enriched with a low-pressure exhaust gas recirculation stream (low-pressure EGR) and/or a high-pressure exhaust gas recirculation stream (high-pressure EGR). The high-pressure exhaust gas recirculation stream is extracted from the exhaust gas stream near to the engine, and the low-pressure exhaust gas recirculation stream is extracted further away from the engine from the exhaust gas stream in the direction of flow of the exhaust gas. In this sense it is possible, for example, for the high-pressure exhaust gas recirculation stream to be extracted upstream of an exhaust gas turbocharger (not illustrated), and for the low-pressure exhaust gas recirculation stream to be extracted downstream of the exhaust gas turbocharger. The spark plug 40 is used only when the engine is a spark ignition engine. If, on the other hand, the engine is diesel engine, the spark plug is dispensed with. Instead, in particular a glow plug and/or an injection nozzle is used.

Different approaches for diagnosing can be used in the engine controller. These include:
a monitor which monitors, as a total control monitor, the result of the EUR rate in the combustion chamber and can be configured, in particular, for lowering emissions,
a monitor which checks the low-pressure exhaust gas recirculation rate. This monitor can have a sensor which is embodied as a Venturi nozzle, in order to perform a specific flow measurement and thereby determine the volume flow of the low-pressure EGR.

A monitor which checks the high-pressure exhaust gas recirculation rate. This monitor can be embodied with a through-flow sensor as, for example, an HFM. The term HFM stands for “hot-film air mass metre” and be embodied for example as a metal device which heats the fresh air and measures the energy which is necessary to maintain this energy status. The larger the quantity of the high-pressure EGR, the less energy is required to maintain the energy status.

A monitor for the VVT/VVL control. These terms stand for variable valve timing and variable valve lift. VVT means that the opening times of the valves (at the inlet side and outlet side) and inter alia the duration of the overlapping opening can be set. VVL, specifically “variable valve lift” stands for different opening paths of the inlet valves. This can be implemented, for example, by means of an axially displaceable camshaft which has cams which are shaped differently on different axial layers. This monitor can detect, for example, by means of an oil pressure measurement of the adjustment device whether a problem is present in this region.

A monitor which is capable of identifying, via a position measurement of a flap of the low-pressure EGR and/or of the high-pressure EGR, whether fault is present in this region.

Optionally, further monitors are possible such as e.g. for the fresh air supply, the fuel supply and/or the drive output torque and/or output rotational speed.

These monitors are capable of detecting long-term small deviations. In addition, large short-term deviations can be detected. These deviations can be understood as the exceeding and undershooting of a setpoint value or the exiting of a setpoint range. One way in which the monitors can detect an inadmissible deviation is a chronological accumulation of the deviations over a specific time period. In this way, it is possible to achieve that relatively small deviations are not overlooked but are instead detected in the accumulation. In this context, the counters can be set to zero again after a specific time period, and subsequent accumulation can be subsequently started. Alternatively, it is possible to use a time window which runs along and which contains an accumulation of the deviation at each point in time over a defined time period.

A system which is equipped in this way is used in the operating modes which are explained below by means of FIGS. 2 to 4. In this example, the inert gas value in the combustion chamber is optimized. The inert gas value is a measure of a good combustion and, for example, the NOx value in the exhaust gas is influenced very strongly by the inert gas value. The inert gas value cannot be measured directly but rather can be obtained by means of calculation, wherein the calculation comprises various input variables of the engine controller. In FIG. 2, an inert gas value is assumed in a virtual variable, wherein this value is understood to be a state of good combustion. FIG. 2 also shows values for the low-pressure EGR, the high-pressure EGR and the VVT/VVL in the form of a bar diagram. In this context, the dashed lines (max and min) each represent upper limits and lower limits for these parameters, and the values which are shown lie very largely centrally in their tolerance ranges. Although different limits are typically provided for the individual parameters, for the sake of a simplified schematic explanation the same limits are considered here in a simplifying fashion. Therefore, in FIG. 2 an operating state is shown in a fault-free ideal state. In this context it is not relevant what this operating state is. It can be, for example, driving at constant speed or, for example, an acceleration state or a cold start. The state which is adjusted in an optimized fashion in FIG. 2 can be implemented by means of in each case one separate control loop for the specified three parameters, for example. In these control loops, in each case the corresponding parameter is changed in such a way that the inert gas value approaches its setpoint value (or setpoint range). Such an adjustment structure can also be considered under certain circumstances to be a known adjustment structure.

In contrast, in FIG. 3 it is detected that the VVT/VVL value has dropped significantly. This reduction would have a corresponding influence on the inert gas value. The influence can be positive or negative in a corresponding fashion. However, since the controller has detected the drop in the VVT/VVL, it can counteract. Depending on certain boundary conditions which are to be complied with and/or which are advantageous and which are explained below in more detail, the controller can decide which of the other parameters (low-pressure EGR and high-pressure EGR) of this example it changes within the predefined limits in order nevertheless to obtain the inert gas value at its setpoint value. In the example in FIG. 3 it is assumed that the shifting of the inert gas value which would be actually brought about by the lowering of the VVT/VVL value can be compensated by increasing the low-pressure EGR and/or the high-pressure EGR. The controller decides on the basis of the specific boundary conditions that it leaves the low-pressure EGR unchanged and increases the high-pressure EGR, with the result that the inert gas value in FIG. 2 remains precisely unchanged with respect to the ideal situation shown in FIG. 1.

Different requirements can be associated with the “specific boundary conditions” mentioned above. These may be, for example, that A:) an optimization to better dynamic driving conditions may be desired, B:) to reduced fuel consumption or C:) to improved emission of particles. If appropriate D:) optimization of the exhaust gas values, e.g. NOx, can also be provided, wherein the latter approach is used rather less in some applications, since this optimization is already achieved largely via the means of optimization of the inert gas value.

In general terms, in the event of fault which is caused by a deviation of a parameter, wherein, in particular, this parameter itself cannot be corrected owing to interference influences, the controller can perform compensation in such a way that it selects, in a targeted fashion and/or after weighing up different compensation strategies (or boundary conditions), a possible way in which the value to be adjusted (here for example the inert gas value,) remains in its setpoint range.

FIG. 4 shows a further alternative in which the VVT/VVL value has dropped extremely and is significantly below the minimum value which is shown in a dashed fashion. In this case, the controller attempts to compensate the fault by virtue of the fact that it runs up the low-pressure EGR and the high-pressure EGR up to the permissible maximum value.

However, an example is shown here in which the inert gas value nevertheless cannot be kept in its setpoint range and drops. Therefore, fault which is no longer to be compensated is present, with the result that a warning has to be output. An objective of the controller is therefore to decide, in the event of fault of a parameter in a separate method step which is provided for that purpose, which other parameter or parameters can be changed in order to avoid a warning message or fault message as far as possible.

The following example is explained without the aid of figures. In this example it is assumed that a fault is detected. This fault can appear as a result of an excessively large value of the inert gas in the combustion chamber. The controller can subsequently detect, through the interrogation of the different sensors, which component has (supposedly) caused this fault. As already explained above, the state of the low-pressure exhaust gas recirculation can be detected. by means of a Venturi sensor. Alternatively, instead of by means of the excessively high inert gas value, the fault can however also be detected directly by interrogating the Venturi sensor. In this example, it is assumed that there is a fault in the low-pressure EGR. As a strategy for compensating the fault, the controller could run up the low-pressure EGR, since in this way the recirculated exhaust gas is connected directly to the setpoint value. However, the controller can use the boundary conditions to arrive at the differing decision that the high-pressure EGR increases the fuel consumption in such a way that it is not advantageous. Therefore, in this example the controller arrives at the result that it is better to increase the overlap of the opening time periods of the inlet valves and outlet valves when controlling the VVT/VVL, since in this way the inert gas value can also be correspondingly optimized and/or corrected.

The optimizations according to low-pressure EGR, high-pressure EGR and VVT/VVL which are mentioned in the above examples are exemplary. It is possible use other influencing factors and/or more influencing factors can be used.

In the present example, the inert gas value in the combustion chamber was considered as the optimization variable. This approach is frequently advantageous, since this variable has a very large influence on the quality of the exhaust gas. However, it is also possible to optimize another variable such as e.g. an exhaust gas value such as, in particular, the NOx value.

1. A method for adjusting an adjustment value of an internal combustion engine such as, in particular, the inert gas value in the combustion chamber of an internal combustion engine, comprising independently adjusting of one another with a controller in a first operating state of the adjustment manipulated variables which influence the adjustment value in order to optimize the adjustment value, and selecting one or more manipulated variables in a second operating state by the controller when a fault or an optimization requirement is detected in order thereby to bring about the optimization of the adjustment value by means of enhanced use of the manipulated variables.

2. The method according to claim 1, wherein sensors are provided for at least some of the manipulated variables, in order to check individually for an assigned manipulated variable whether the assigned manipulator valve is set to the predefined value.

3. Method according to claim 1, wherein at least two of the following manipulated variables are used:
a low-pressure EGR rate,
a high-pressure EGR rate,
a VVT and/or VVL value,
a fresh gas supply,
a quantity of the fuel supply
and the method preferably uses the first-mentioned three manipulated variables.

4. The method according to claim 1, wherein in order to determine the adjustment value the controller adjusts at least three manipulated variables, and adjusts precisely three manipulated variables for this purpose.

5. The method according to claim 1, wherein the controller determines the inert gas value in the combustion chamber on the basis of predefined and/or measured engine conditions and uses the value as an adjustment value.

6. The method according claim 1, wherein deviations of the adjustment value from the setpoint value are summed over a defined time period, and when the summed deviations are exceeded or undershot in comparison with a limiting value, a fault or an optimization requirement is detected, and in particular the method is additionally configured to detect one-off deviations of the adjustment value from a limiting value.

7. The method according to claim 1, wherein when a fault or an optimization requirement is detected, the value of the manipulated variables which are provided with an individually assigned sensor is interrogated in order thereby to detect a manipulated variable which operates in a non-optimum fashion, and subsequently at least one other manipulated variable is selected in order to use said manipulated variable to compensate the manipulated variable which operates in a non-optimum fashion.

8. An engine controller for an engine, wherein the engine controller is configured to carry out a method according to claim 1.

9. An engine having an engine controller configured to carry out the method of claim 1.

10. A method for adjusting an adjustment value of an internal combustion engine, comprising setting a plurality of manipulated variables are set to predefined values in order to obtain a desired adjustment value, and selecting a manipulated valve to be changed either alone or in combination with other manipulated variables with the controller when the adjustment value differs from a setpoint value, in order to compensate for the deviation.
